(19) United States
(12) Patent Application Publication
(10) Pub. No.: US 2003/0188644 A1
(43) Pub. Date: Oct. 9, 2003

(54) Pressing device

(76) Inventors: Carsten Winter, Bremen (DE); Dirk Werstrup, NeunenKirchen-V?ouml;rden (DE)

Correspondence Address: MERCHANT & GOULD PC, P.O. BOX 2903, MINNEAPOLIS, MN, 55402-0903, US

(21) Appl. No.: 10/221,435

(22) PCT Filed: Mar. 9, 2001
(86) PCT No.: PCT/EP01/02674

(30) Foreign Application Priority Data
Mar. 10, 2000 (DE) 10011859.3

(51) Int. Cl. B30B 1/18

(52) U.S. Cl. 100/280

(57) ABSTRACT

The invention relates to a pressing device, comprising an electric motor (1), a reduction gear (2) and a spindle drive (3). According to the invention, the reduction gear is in the form of a planet gear and the spindle drive (3) is a planet roller-screw spindle drive. The threaded nut (32) acts upon a pressing tool (4) and is guided in a linear direction in a rotatably fixed manner.

The invention concerns a pressing device comprising an electric motor, a reduction gear and a spindle drive for conversion of a rotary movement into a linear movement of a pressing tool, and having a path sensor for determining the path traveled, as well as a sensor for determining the pressing force of the pressing tool.

A device of this kind is already known from DE GM 90 14 783. In the case of this known motor-driven pressing device a screw spindle is journaled in rotationally-fixed but axially-displaceable fashion, while a nut driven by an electric motor over a reduction gear is journaled in rotational and non-displaceable fashion. The non-rotational screw spindle is coupled with a pressing tool.

However, this known pressing device has various disadvantages. For one thing, the axial bearing support of the rotationally-fixed screw spindle is relatively expensive, and for another thing only relatively low pressing forces can be achieved. Moreover, the force exerted on the pressing tool is measured directly at the axial bearing support of the threaded nut, which, because of the high pressing forces effective there, produces unstable conditions.

The object of this invention is to improve a pressing device of the initially mentioned type that can generate extraordinarily high pressing forces and that can measure both the pressing forces and the path traveled by the pressing tool in a simple and precise manner.

This objective is met in accordance with this invention in that provided as reduction gearing is planetary gearing and as a spindle drive a planet roller-screw spindle drive; that the screw spindle is directly coupled with the output shaft of the planetary gearing, and that the threaded nut acts upon the pressing tool and is guided as an inner sleeve in an outer, housing-fast external sleeve with opposing involute gearing for rotationally-fixed support of the moment of reaction in the linear direction.

The pressing device in accordance with the invention, relative to the known devices, has the advantage that it can be constructed to be relatively compact and slim, and that very high pressing forces, with simultaneously more precise measurement of the path traveled, can be achieved.

A particularly stable and effective bearing support of the screw spindle can be obtained with this type of construction through means of a tapered roller bearing, in order to take up the axial forces of the screw spindle.

The electric motor is preferably an electronically controlled or regulated electric motor with an angle encoder on the motor shaft. The angle signals of the angle encoder will be drawn upon for calculating the travel path of the pressing tool, taking into account the reduction ratio of the reduction gear and the pitch of the spindle drive. For determining the pressing force of the pressing tool, based on one advantageous form of embodiment, provided in the planetary gearing is a torque sensor for determining the transferred torque, and the measured torque will be drawn upon for calculating the pressing force of the pressing tool, taking into account the reduction ratio of the reduction gear and pitch of the spindle drive. Provided here as a torque sensor, preferably arranged in the support section of the planetary gearing, are strain gauges that are connected via an appropriate measurement circuit.

The planetary gearing is preferably constructed to be multistage. Another advantageous form of execution is characterized by a spring-loaded end stop constructed as a thrust washer for the pressing tool or, to be precise, for accommodating the pressing tool mounting, with which the zero position for path measurement is determined upon the return stroke.

Other advantageous embodiments of the invention are contained in the following sub-claims.

The invention will be explained in more detail with an example of execution, with reference to the accompanying drawings.

Shown are:

1. a longitudinal section through the pressing device in accordance with the invention where, for reasons of space in the representation, the top section with the electric motor is drawn in a cutaway;

2. a cross section II-II in the region of the spindle drive;

3. a cutout from the top section of the spindle drive.

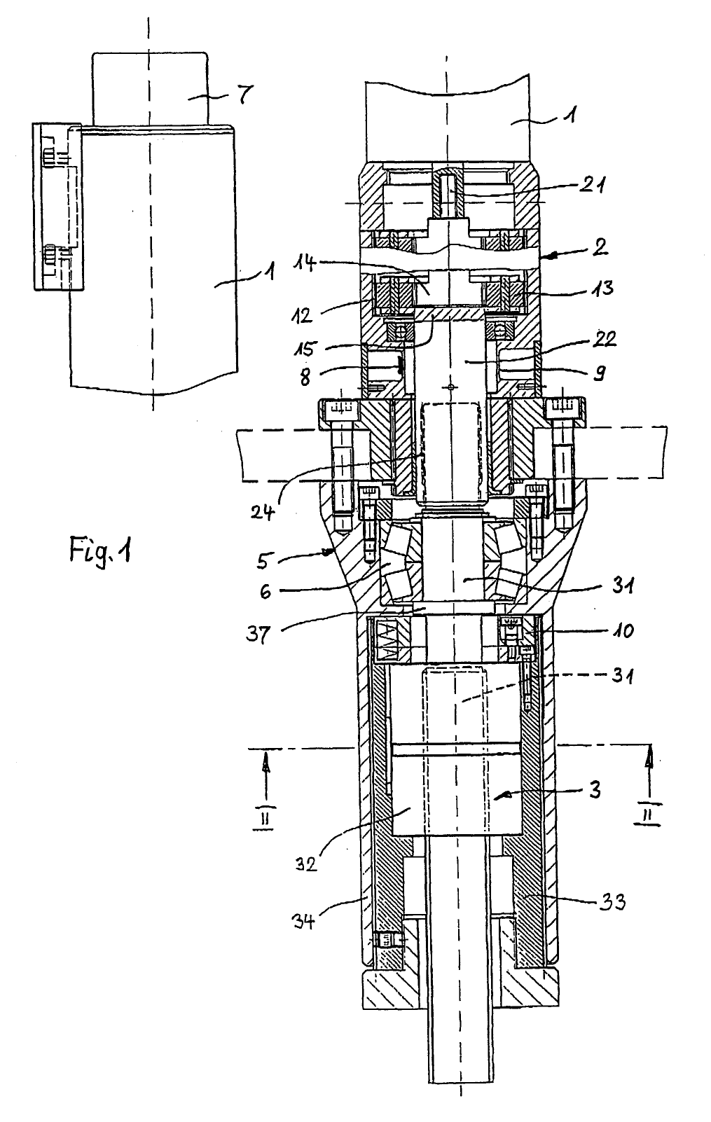

In the longitudinal cut representation of the pressing device in accordance with the invention based on FIG. 1, to be seen in the top section is an electric motor 1 that displays an angle encoder 7 placed directly on the motor shaft. In this example, the electric motor is an electronically controlled servomotor, where sensing of the angle of rotation is accomplished through the angle encoder 7. Coupled with the motor shaft of the electric motor 1 is the input shaft 21 of a multi-stage planetary gearing 2, while the output shaft 22 of the planetary gearing 2 is coupled with a screw spindle 31 of a spindle drive 3 via an appropriate spline gearing 24.

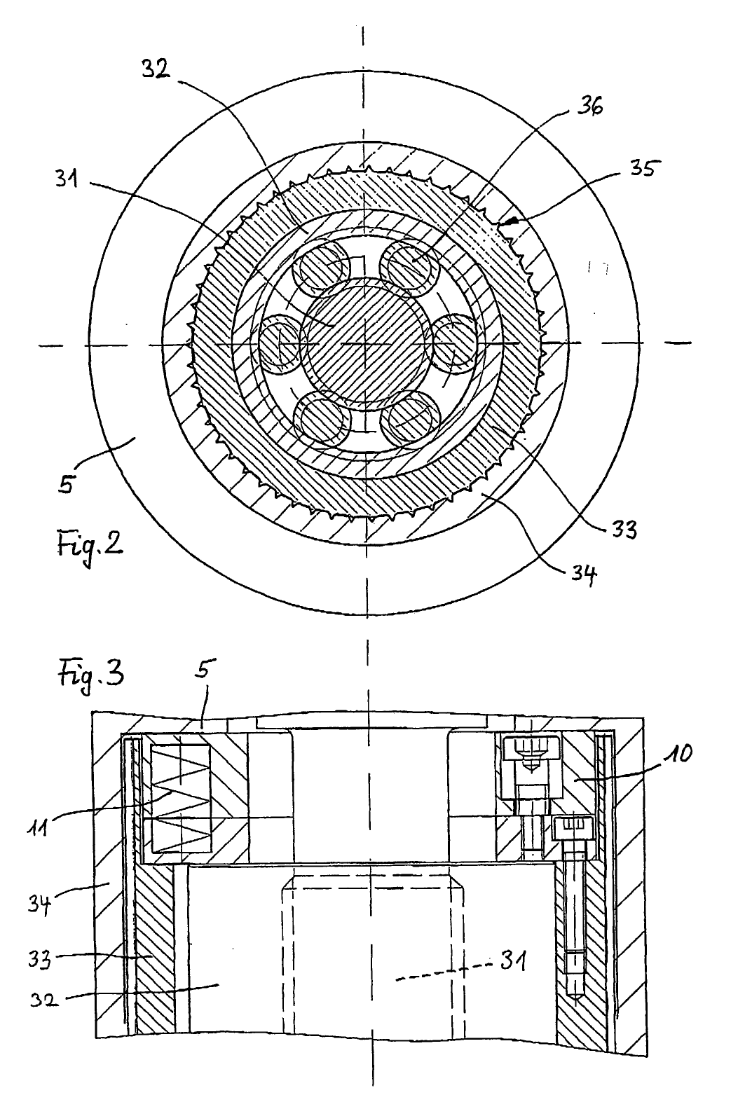

The screw spindle 31, together with a screw nut 32 and rollers 36, forms a planetary roller-screw spindle drive that has particularly low friction and that can transfer high forces. For additional details see also section II-II based on FIG. 2.

The screw spindle 31 is supported in the axial direction against housing 5 by a flanged stop 37 and a tapered roller bearing 6. The screw nut 32 is connected with an inner sleeve 33 that is provided with an involute gearing 35. Housing 5 is provided with a housing projection that forms an outer sleeve 34. This outer sleeve 34 is also provided with an involute gearing 35, so that the inner sleeve 33 is journaled in the outer sleeve 34 in rotationally-fixed and axially-displaceable fashion. Joined with the inner sleeve 33 is a mounting 4 for a pressing tool.

Now, in order to determine the path traveled by the tool mounting 4 or, to be precise, the screw nut 32, a travel measurement is not taken directly at these parts as is the case of the state of the art but rather by means of the available angle encoder 7 on the electric motor 1. The travel path of the pressing tool mounting 4 are [sic] calculated from the angle signals of the angle encoder 7 by means of an appropriate calculation circuit, taking into consideration the reduction ratio of the reduction gearing 2 and taking into consideration the pitch of the spindle drive 3. In this way, it is possible to determine precisely and with high resolution the travel path of the pressing tool, or rather, of the pressing tool mounting 4,

The multi-stage-designed planetary gearing 2 displays, in known manner, per stage, one sun wheel 14 as well as a plurality of planet pinions 13, rotatably journaled on a planet cage 15, which move in rolling contact in an inner gearing 12 of the stationary housing 5. The input shaft of each stage of the planetary gearing 2 is coupled with the sun wheel 14, while the output shaft 22 is coupled with the pinion cage 15. When transferring a load, the planet pinions 13 are supported, moving in rolling contact on the inner gearing 12. The reaction moment of this supporting force acts on a narrowed region 9 of the housing 5, where strain gauges 8 are arranged as torque sensors.

Therefore, the pressing force exerted on the pressing tool 4 is determined by measurement of the torque exerted on the spindle drive 3, and actually through the torque sensor 8 integrated into the planetary gearing 2 in the form of strain gauges. The torque measured by the torque sensor 8 in the planetary gearing 3 [sic] will then be converted into a pressing force corresponding to the reduction ratio of the planetary gearing 2 and the spindle pitch of the spindle drive 3, which acts on pressing tool 4. Since in the present case the torque sensor 8, that is the strain gauge, is arranged in the last gear stage of the planetary gearing, the torque that is determined corresponds to the torque on the screw spindle 31, so that only the pitch of the spindle drive 3 needs yet to be taken into account in making the calculation.

However, it is also possible, instead of the measurement of the torque in the planetary gearing 2, to measure the motor current of the electric motor 1 and from this determine the torque at the output shaft of the electric motor 1, from which the pressing force on the pressing tool 4 can be calculated, taking into consideration the parameters of planetary gearing 2 and of spindle drive 3.

As is in particular obtained from FIG. 3, provided in the upper region of the spindle drive 3 is an end stop 10 in the form of a stop disk that is supported by a strong spring 11. With restoring movement of the spindle drive 3, the threaded nut 32 runs up against this end stop 10, whereby the torque sensor 8 detects an increase in the torque, whereupon the return stroke speed is reduced. When driving against the end stop 10 the torque climbs rapidly and the electric motor is switched off. This position is defined as the zero setting.

1. Pressing device comprising an electric motor (1), reduction gearing (2) and a spindle drive (3) for conversion of a rotary movement into a linear movement of a pressing tool (4), and having a path sensor for determining the path traveled, as well as a sensor for determining the pressing force of the pressing tool (4), characterized by the fact that provided as reduction gearing (2) is planetary gearing, and as a spindle drive (3) a planet roller-screw spindle drive; that the screw spindle (31) is coupled directly with the output shaft (22) of the planetary gearing (2), and that the threaded nut (32) acts upon the pressing tool (4), and is guided in rotationally-fixed fashion as an inner sleeve (33) in an external, outer sleeve (34) with opposing involute gearing (35), fixed to the housing, for supporting the reaction moment in the linear direction.

2. Pressing device according to claim 1, characterized by the fact that the screw spindle (31) is journaled in the housing (5) through a tapered roller bearing (6) and is supported with reference to the axial forces.

3. Pressing device according to claim 1 or 2, characterized by the fact that the electric motor (1) is an electronically controlled electric motor with an angle encoder (7) on the motor shaft, and that the angle signals of the angle encoder (7), taking into account the reduction ratio of the reduction gearing (2) and the pitch of the spindle drive (3), will be drawn upon for calculating the path traveled by the pressing tool (4).

4. Pressing device according to claims 1-3, characterized by the fact that provided in the planetary gearing (2) is a torque sensor (8) for determination of the transferred torque, and that the measured torque, taking into account the reduction ratio of the reduction gear (2) and the pitch of the spindle drive (3), will be drawn upon for calculation of the pressing force of the pressing tool (4).

5. Pressing device according to claim 4, characterized by the fact that provided as torque sensor (8) are strain gauges disposed in the support region of the planetary gearing (2).

6. Pressing device according to claim 5, characterized by the fact that the torque sensor (8) is disposed in the support region of the last stage of the planetary gearing (2).

7. Pressing device according to one of claims 1 to 3, characterized by the fact that, for calculation of the pressing force of the pressing tool, the current consumption of the electric motor will be drawn upon for determining the torque introduced by the motor, and this latter, taking into account the reduction ratio of the reduction gear (2) and the pitch of the spindle drive (3).

8. Pressing device according to one of the claims 1 to 7, characterized by a multi-stage planetary gearing (2).

9. Pressing device according to claims 3 and 4, characterized by a spring-loaded end stop (10) constructed as a stop disk for the pressing tool (4) with which is determined, during the return stroke, the zero setting for path measurement.
